(19) United States
(12) Patent Application Publication
(10) Pub. No.: US 2020/0298627 A1
(43) Pub. Date: Sep. 24, 2020

(54) PNEUMATIC TIRE

(71) Applicant: Toyo Tire Corporation, Itami-shi (JP)

(72) Inventor: Tsuyoshi Fujioka, Itami-shi (JP)

(73) Assignee: Toyo Tire Corporation, Itami-shi (JP)

(21) Appl. No.: 16/807,726

(22) Filed: Mar. 3, 2020

(30) Foreign Application Priority Data
Mar. 18, 2019 (JP) 2019-049381

(51) Int. Cl. B60C 11/12; B60C 11/03

(52) U.S. Cl. CPC B60C 11/1218; B60C 11/0306; B60C 2011/1254; B60C 2011/1213; B60C 11/1236

(57) ABSTRACT

A tire has a first block that is partitioned by a first pair of major grooves, the first block land making up a first block column arranged along a tire circumferential direction. The first block land has a first closed sipe and a first open sipe. The first closed sipe appears wavelike as seen in plan view, extends in a tire width direction, and has two ends that respectively terminate within the first block. The first open sipe appears wavelike as seen in plan view and has two ends that respectively open into the first pair of major grooves central location in the tire circumferential direction of the first block land. An amplitude of the first open sipe is greater than amplitude of the first closed sipe. A wavelength of the first open sipe is less than wavelength of the first closed sipe.

### BACKGROUND OF THE INVENTION

The present disclosure relates to a pneumatic tire.

Included among pneumatic tires are those which are intended for heavy loads such as may be used for trucks, buses, and the like, among which there are studless tires and other such winter tires for which it is desired that there be improved performance on icy road surfaces.

Japanese Patent No. 5532696 discloses a tire in which formed at a block land there are a major sipe which is contiguous with a major groove, and a minor sipe that terminates within the block land, it being described that performance on icy road surfaces is attained, and that uneven wear on dry road surfaces is suppressed.

However, attainment of performance on ice and further suppression of uneven wear are desired.

### SUMMARY OF THE INVENTION

It is an object of the present disclosure to provide a pneumatic tire that permits attainment of performance on ice as well as suppression of uneven wear.

According of the present disclosure, there is provided a pneumatic tire comprising:

at least one first block land that is partitioned by at least one first pair of major grooves and at least one first pair of lateral grooves, the at least one first block land making up at least one first block column arranged along a tire circumferential direction;

wherein the at least one first block land has at least one first closed sipe and at least one first open sipe;

wherein the at least one first closed sipe appears wavelike as seen in plan view, extends in a tire width direction, and has two ends that respectively terminate within the at least one first block land;

wherein the at least one first open sipe appears wavelike as seen in plan view and has two ends that respectively open into the at least one first pair of major grooves at at least one central location in the tire circumferential direction of the at least one first block land; and

wherein amplitude of the at least one first open sipe is greater than amplitude of the at least one first closed sipe; and

wherein wavelength of the at least one first open sipe is less than wavelength of the at least one first closed sipe.

### BRIEF DESCRIPTION OF THE DRAWINGS

FIG. 1 Drawing of tire meridional half-section showing an example of a pneumatic tire associated with the present embodiment.

FIG. 2 Plan view showing tread pattern in accordance with the present embodiment.

FIG. 3 Enlarged plan view showing central land and mediate lands.

FIG. 4 Plan view, view of section in width direction, and view of section in long direction showing closed sipe and open sipe.

FIG. 5 Enlarged plan view showing shoulder block land.

### DETAILED DESCRIPTION OF THE PREFERRED EMBODIMENTS

Below, a pneumatic tire in an embodiment in accordance with the present disclosure is described with reference to the drawings. In the drawings, “CD” refers to the tire circumferential direction, “WD” refers to the tire width direction, and “RD” refers to the tire radial direction. The respective drawings show shapes as they would exist when the tire is still new.

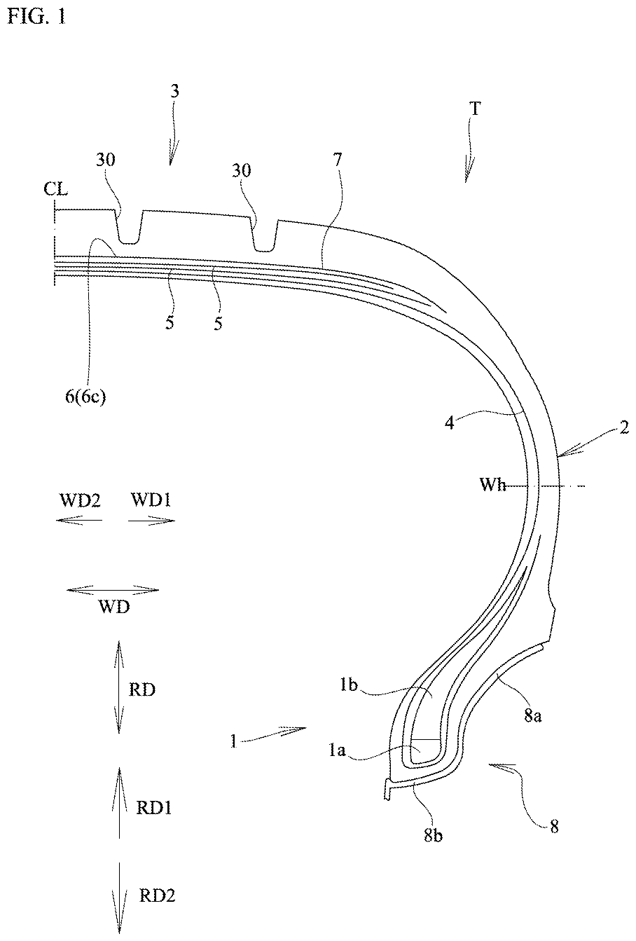

As shown in FIG. 1, pneumatic tire T is provided with a pair of bead 1; sidewall 2 which extend toward the exterior RD1 in the tire radial direction from the respective bead 1; and tread 3 which mutually connects the ends toward the exterior RD1 in the tire radial direction of the sidewall 2. Arranged at bead 1 are annular bead core 1a at which steel wire or other such convergent body is coated with rubber, and bead filler 1b which comprises hard rubber. Bead 1 is mounted on bead sheet 8b of rim 8, and—provided that the air pressure is as it should be (e.g., air pressure as determined by JATMA)—is fitted in appropriate fashion to rim flange 8a by virtue of the tire internal pressure, such that the tire is made to engage with rim 8.

Furthermore, this tire is provided with toroidal carcass layer 4 which is arranged so as to span the distance between the pair of bead 1 and which extends from tread 3 and passes through sidewall 2 to reach bead 1. Carcass layer 4 is made up of at least one carcass ply, and has end regions that are routed by way of bead cores 1a to be retained in upturned fashion. Arranged toward the inside circumferential surface of carcass layer 4 is inner liner rubber (not shown) for retention of air pressure.

Arranged at the outside circumferential surface of carcass layer 4 at tread 3 is belt layer 5 which reinforces carcass layer 4 by virtue of the barrel hoop effect. Belt layer 5 has two belt plies that have cords which extend so as to be inclined by prescribed angle(s) with respect to the tire circumferential direction, the respective plies being laminated together in such fashion that the cords thereof intersect in mutually oppositely inclined fashion. Arranged toward the outside circumferential surface of belt layer 5 is belt reinforcing layer 7, and arranged at the outside circumferential surface further in that direction therefrom is the tread rubber at which the tread pattern is formed.

As examples of rubber raw material for the aforementioned rubber layers and so forth, natural rubber, styrene-butadiene rubber (SBR), butadiene rubber (BR), isoprene rubber (IR), butyl rubber (IIR), and so forth may be cited, it being possible for any one of these to be used alone, or for any two or more of these to be used in combination. Furthermore, such rubber(s) may be reinforced with carbon black, silica, and/or other such filler, and vulcanizing agent, vulcanization accelerator, plasticizer, antioxidant, and/or the like may be blended thereinto as appropriate.

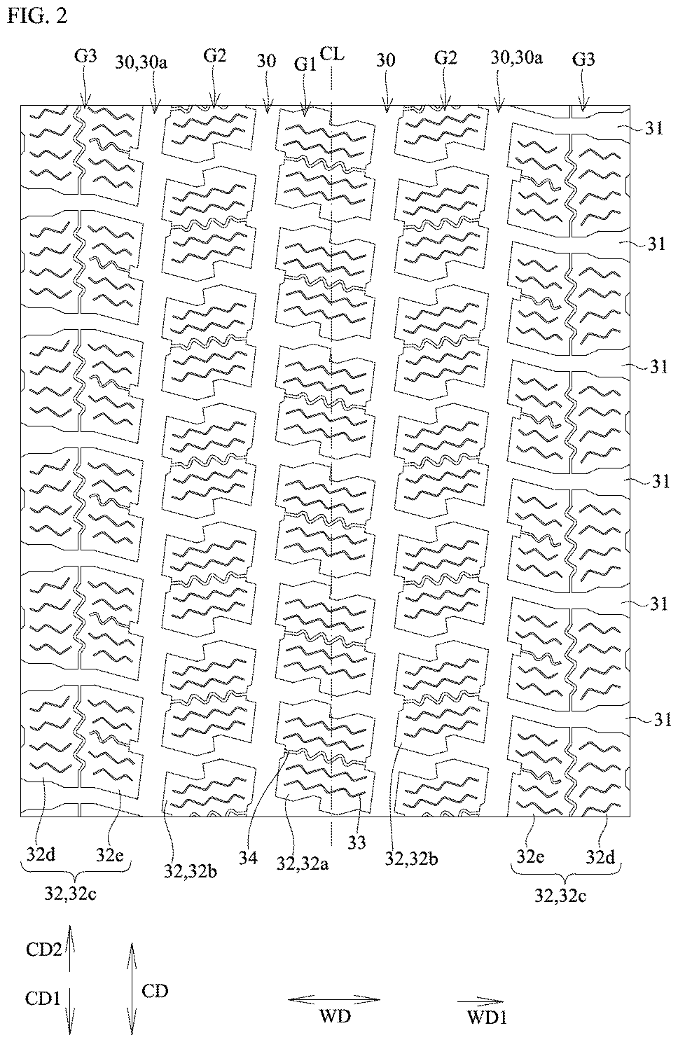

FIG. 2 is a plan view showing the tread pattern at a tire in accordance with the present embodiment. As shown in FIG. 2, at the tread of a tire in accordance with the present embodiment, a plurality of major grooves 30 and a plurality of lateral grooves 31 are formed. Presence of major grooves 30 and lateral grooves 31 cause a plurality of block lands 32 to be arrayed along the tire circumferential direction. The tire shown by way of example in FIG. 2 has first column of blocks G1 and second column of blocks G2. First block column G1 has a plurality of block lands 32 (central lands 32a) that are arranged so as to pass through the tire equator CL. Second block column G2 has a plurality of block lands 32 (mediate lands 32b) that are arranged along the tire circumferential direction CD in such fashion as to be adjacent to first block column G1. Furthermore, the tread has a third column of blocks G3. Third block column G3 has a plurality of shoulder block lands 32c. The plurality of shoulder block lands 32c are arranged along the tire circumferential direction CD in such fashion as to be partitioned by lateral grooves 31 and outermost major grooves 30a arranged in outwardmost fashion in the tire width direction WD. Whereas all of the lands at the tread in the example of FIG. 2 are block lands, there is no limitation with respect thereto. For example, some of the land(s) may be provided in the form of rib(s) that are not partitioned by lateral groove(s) but extend in continuous fashion in the tire circumferential direction CD.

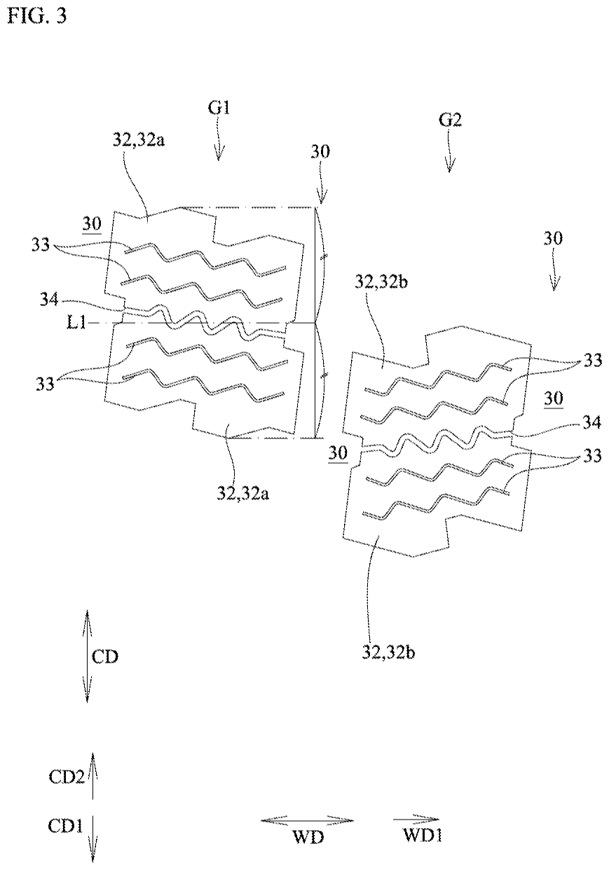

As shown in FIG. 2 and FIG. 3, central land 32a and mediate land 32b each has a plurality of closed sipes 33 that appear wavelike as seen in plan view and open sipes 34 that appear wavelike as seen in plan view. Closed sipe 33 extends in the tire width direction WD in such fashion as to terminate within a block land. Open sipe 34 extends in the tire width direction WD in such fashion that, at the central portion in the tire circumferential direction of a block land 32, the two ends thereof open into major grooves 30. Where it is said that open sipe 34 is arranged at a central portion in the tire circumferential direction, this means that it is sufficient that open sipe 34 overlap the center line L1 in the tire circumferential direction thereof. Thus, the fact that open sipe 34 approximately bisects block land 32 makes it possible to suppress worsening of uneven wear of the lands that are spaced apart by virtue of being to either side in the tire circumferential direction CD of open sipe 34.

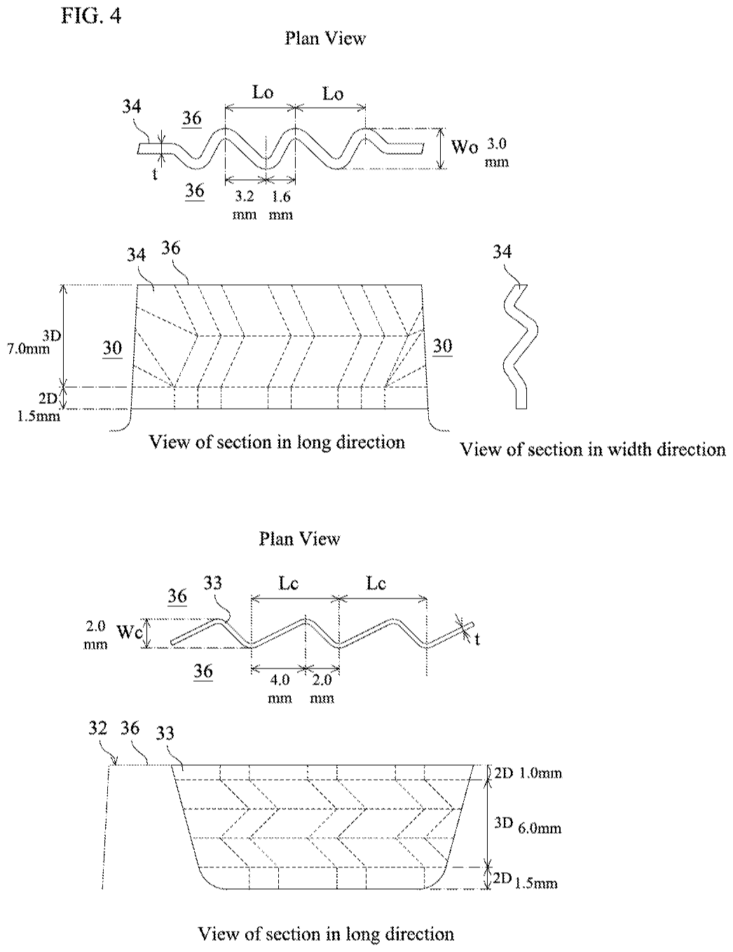

FIG. 4 shows closed sipe 33 and open sipe 34. As shown in FIG. 4, amplitude Wo of open sipe 34 is greater than amplitude Wc of closed sipe 33. Wavelength Lo of open sipe 34 is shorter than wavelength Lc of closed sipe 33. When such relationships exist between amplitudes and wavelengths, the wall surfaces of open sipes 34 will be more likely to come in contact with each other than will those of closed sipes 33, suppressing excessive movement of block lands 32 due to presence of open sipes 34. To appropriately cause occurrence of the effect whereby excessive movement of block lands 32 is suppressed as a result of contact of sipe wall surfaces with each other, it is preferred that the lengths of open sipe 34 and closed sipe 33 be respectively not less than two periods. Note that sipe amplitude and wavelength are defined with reference to the direction in which the sipes extend.

Whereas amplitude Wo of open sipe 34 in the embodiment shown in FIG. 4 is 3.0 mm, there is no limitation with respect thereto. It is, for example, preferred that amplitude Wo of open sipe 34 be not less than 1.0 mm but not greater than 5.0 mm. Whereas wavelength Lo of open sipe 34 is 4.8 mm, there is no limitation with respect thereto. It is, for example, preferred that wavelength Lo of open sipe 34 be not less than 3.0 mm but not greater than 7.0 mm.

Whereas in the embodiment shown in FIG. 4 amplitude Wc of closed sipe 33 is 2.0 mm, amplitude Wo of open sipe 34 being 1.5 times amplitude Wc of closed sipe 33, there is no limitation with respect thereto. It is preferred that amplitude Wo of open sipe 34 be not less than 1.2 times but not greater than 3.0 times amplitude Wc of closed sipe 33. The reason for this is that if Wo/Wc were to be less than 1.2, this would decrease the effect whereby excessive movement of block lands 32 is suppressed, which would contribute to occurrence of uneven wear. To improve performance on ice, it will be effective to decrease the size of block lands 32 and to increase the number of sipes (increase sipe density). But if Wo/Wc were to be greater than 3.0, this would cause the amplitude of open sipes 34 to become too large, which would decrease the number of closed sipes 33 that are provided (decrease sipe density), making it difficult to decrease the size of block lands 32 and increase the number of sipes, which would contribute to lowering of performance on ice.

Whereas in the embodiment shown in FIG. 4 wavelength Lc of closed sipe 33 is 6.0 mm, wavelength Lo of open sipe 34 being 0.8 times wavelength Lc of closed sipe 33, there is no limitation with respect thereto. It is preferred that wavelength Lo of open sipe 34 be not less than 0.5 times but not greater than 0.9 times wavelength Lc of closed sipe 33. The reason for this is that if Lo/Lc were to be greater than 0.9, this would decrease the effect whereby excessive movement of block lands 32 is suppressed, which would contribute to occurrence of uneven wear. And if Lo/Lc were to be less than 0.5, because the corners of open sipes 34 would become too acute, they would tend to act as sites for initiation of uneven wear and/or sites for initiation of cracking.

As shown in FIG. 2 and FIG. 3, open sipes 34 and closed sipes 33 of first block column G1, and open sipes 34 and closed sipes 33 of second block column G2, are inclined in mutually opposite fashion with respect to the tire width direction WD. By way of example, open sipes 34 and closed sipes 33 of first block column G1 are inclined so as to be directed downward as one proceeds to the right. Stating this another way, the sipes in first block column G1 extend so as to be directed toward first direction WD1 in the tire width direction and first direction CD1 in the tire circumferential direction. Open sipes 34 and closed sipes 33 of second block column G2 are inclined so as to be directed upward as one proceeds to the right. Stating this another way, the sipes in second block column G2 extend so as to be directed toward first direction WD1 in the tire width direction and second direction CD2 in the tire circumferential direction. If sipes 33, 34 were all inclined in the same direction, the traction produced by sipes 33, 34 would cause the tire to drift toward one side in the tire width direction. In accordance with the present embodiment, because the respective sipes 33, 34 in mutually adjacent first block column G1 and second block column G2 are inclined in mutually opposite directions with respect to the tire width direction WD, it is possible to prevent the traction produced by sipes 33, 34 from causing drift toward one side in the tire width direction WD.

Whereas the closed sipes 33 and open sipes 34 shown in FIG. 4 are 3D sipes, there is no limitation with respect thereto, it also being possible to employ 2D sipes. A 3D sipe is a sipe that extends in such fashion as to deform three-dimensionally (the tire circumferential direction, tire width direction, and tire depth direction). A 2D sipe is a sipe that extends in such fashion as to deform two-dimensionally (the tire circumferential direction and tire width direction), inasmuch as it does not deform in the tire depth direction. As shown in same drawing, closed sipe 33 and open sipe 34 both have the same sipe depth, i.e., 8.5 mm, there being a 2D sipe portion (2D) at the bases of the sipes. The 2D sipe portion is 1.5 mm in the depth direction. Open sipe 34 has a 3D sipe portion (3D) from the tread surface 36 to a region near the base of the sipe. Closed sipe 33 has a 2D sipe portion (2D) from the tread surface 36 to a prescribed depth, has a 3D sipe portion (3D) below the 2D sipe portion (2D), and has another 2D sipe portion (2D) below the 3D sipe portion.

Whereas FIG. 4 shows open sipe 34 having a sipe width t of 0.7 mm, and shows closed sipe 33 having a sipe width of 0.3 mm, there is no limitation with respect thereto. It is, for example, preferred that sipe width be not less than 0.3 mm but not greater than 1.0 mm. It is preferred that the sipe width of the 3D sipe portion be not less than 1.5 times but not greater than 3.0 times the sipe width t of the 2D sipe portion. While a large sipe width t will improve performance on ice as a result of improvement in performance with respect to water delivery, it will conversely also reduce the rigidity of block land 32. But because open sipe 34 is arranged in the central portion of block land 32, whatever effect increasing the sipe width t of open sipe 34 may have in reducing the rigidity of block land 32 will be limited and small, and good balance will be achieved between open sipe 34 and closed sipe 33.

Between the time when the tire is new until the middle stage of wear, because sipe depth is large and rigidity of block land 32 is low, there is a tendency for there to be much movement of block land 32 itself. Because, as shown in FIG. 4, a constitution is therefore adopted in which a 2D sipe portion (2D) is arranged at the base of the sipe, and a 3D sipe portion (3D) is arranged thereabove, excessive movement of block land 32 can be suppressed by the 3D sipe portion, making it possible to suppress occurrence of uneven wear and reduction in performance on ice. On the other hand, after the middle stage of wear, as there is a decrease in sipe depth and an increase in the rigidity of the block land 32 itself, adoption of a 3D sipe shape would cause movement of block land 32 to be constrained and would decrease its ability to conform to the road surface. By therefore employing a 2D sipe portion (2D) at the base of the sipe, it is possible to appropriately permit movement of block land 32, as a result of which it is possible to increase ability to conform to the road surface and suppress occurrence of uneven wear.

Furthermore, as shown in FIG. 4, the fractional portion of open sipe 34 that is occupied in the tire depth direction by the 3D sipe of open sipe 34 is greater than the fractional portion of closed sipe 33 that is occupied in the tire depth direction by the 3D sipe of closed sipe 33. By thus causing the fractional portion of open sipe 34 that is occupied by the 3D sipe thereof to be greater than the fractional portion of closed sipe 33 that is occupied by the 3D sipe thereof, it will be possible to better suppress excessive movement of blocks and suppress occurrence of uneven wear and reduction in performance on ice.

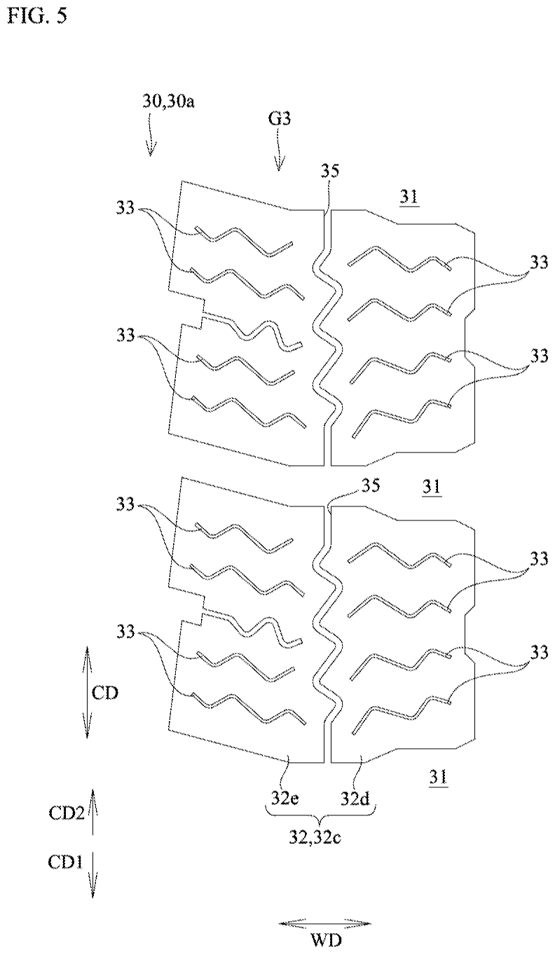

As shown in FIG. 2 and FIG. 5, shoulder block lands 32c have longitudinal open sipes 35 that appear wavelike as seen in plan view. Longitudinal open sipe 35, the two ends of which open into lateral grooves 31, partitions shoulder block land 32c into outer land 32d and inner land 32e in the tire width direction WD. During turns, a lateral force acts on shoulder block land 32c, causing occurrence of a type of motion in which outer land 32d at shoulder block land 32c is made to slide in the tire circumferential direction CD relative to inner land 32e. Because longitudinal open sipes 35 are sipes that appear wavelike as seen in plan view, it is possible to reduce excessive movement of outer land 32d at shoulder block land 32c relative to inner land 32e, and it is possible to suppress uneven wear. To appropriately cause occurrence of the effect whereby uneven wear is suppressed, it is preferred that the amplitude of longitudinal open sipe 35 be at least 2.0 mm or more. Furthermore, to appropriately cause occurrence of the effect whereby uneven wear is suppressed, it is preferred that the length of longitudinal open sipe 35 be at least two periods or more. Note that shoulder block land 32c—like central lands 32a and mediate lands 32b—has a plurality of closed sipes 33.

As described above, a pneumatic tire in accordance with the present embodiment having at least one first block land (32; 32a; 32b) that is partitioned by at least one first pair of major grooves 30 and at least one first pair of lateral grooves 31, the at least one first block land (32; 32a; 32b) making up at least one first block column (G1; G2; G3) arranged along a tire circumferential direction CD; wherein the at least one first block land (32; 32a; 32b) has at least one first closed sipe 33 and at least one first open sipe 34; wherein the at least one first closed sipe 33 appears wavelike as seen in plan view, extends in a tire width direction WD, and has two ends that respectively terminate within the at least one first block land (32; 32a; 32b); wherein the at least one first open sipe 34 appears wavelike as seen in plan view and has two ends that respectively open into the at least one first pair of major grooves 30 at at least one central location in the tire circumferential direction CD of the at least one first block land (32; 32a; 32b); and wherein amplitude Wo of the at least one first open sipe 34 is greater than amplitude Wc of the at least one first closed sipe 33; and wherein wavelength Lo of the at least one first open sipe 34 is less than wavelength Lc of the at least one first closed sipe 33.

Thus, by providing open sipes 34 and closed sipes 33, it is possible to cause performance on ice to be improved as a result of the edge effect of sipes 33, 34. But because block lands 32 are made to move more by open sipes 34 than by closed sipes 33, there is a tendency for this to lead to uneven wear of the lands to either side of open sipe 34.

Because open sipe 34, the two ends of which open into major grooves 30, is therefore arranged in the central portion in the tire circumferential direction of block land 32, it is possible to suppress worsening of uneven wear of the lands that are spaced apart by virtue of being to either side in the tire circumferential direction CD of open sipe 34. At the same time, because amplitude Wo of open sipe 34 is made greater than amplitude Wc of closed sipe 33, and wavelength Lo of open sipe 34 is made less than wavelength Lc of closed sipe 33, there is increased tendency for the wall surfaces of open sipe 34 to come in contact with each other and excessive movement of block lands 32 due to presence of open sipes 34 is suppressed, making it possible to suppress uneven wear while attaining performance on ice.

As is the case in the present embodiment, it is preferred that the amplitude Wo of the at least one first open sipe 34 is not less than 1.2 times but not greater than 3.0 times the amplitude Wc of the at least one first closed sipe 33.

Thus, the reason for this is that if Wo/Wc were to be less than 1.2, this would decrease the effect whereby excessive movement of block lands 32 is suppressed, which would contribute to occurrence of uneven wear. To improve performance on ice, it will be effective to decrease the size of block lands 32 and to increase the number of sipes (increase sipe density). But if Wo/Wc were to be greater than 3.0, this would cause the amplitude of open sipes 34 to become too large, which would decrease the number of closed sipes 33 that are provided (decrease sipe density), making it difficult to decrease the size of block lands 32 and increase the number of sipes, which would contribute to lowering of performance on ice.

As is the case in the present embodiment, it is preferred that the wavelength Lo of the at least one first open sipe 34 is not less than 0.5 times but not greater than 0.9 times the wavelength Lc of the at least one first closed sipe 33.

Thus, the reason for this is that if Lo/Lc were to be greater than 0.9, this would decrease the effect whereby excessive movement of block lands 32 is suppressed, which would contribute to occurrence of uneven wear. And if Lo/Lc were to be less than 0.5, because the corners of open sipes 34 would become too acute, they would tend to act as sites for initiation of uneven wear and/or sites for initiation of cracking.

As is the case in the present embodiment, it is preferred that the amplitude Wo of the at least one first open sipe 34 is not less than 1.0 mm but not greater than 5.0 mm; and the wavelength Lo of the at least one first open sipe 34 is not less than 3.0 mm but not greater than 7.0 mm. This is a preferred embodiment.

As is the case in the present embodiment, it is preferred that the tire has at least one second block land (32, 32b) that is partitioned by at least one second pair of major grooves 30 and at least one second pair of lateral grooves 31, the at least one second block land (32, 32b) making up at least one second block column G2 arranged along the tire circumferential direction CD; wherein the at least one second block land (32, 32b) has at least one second closed sipe 33 and at least one second open sipe 34; wherein the at least one second closed sipe 33 appears wavelike as seen in plan view, extends in the tire width direction WD, and has two ends that respectively terminate within the at least one second block land (32, 32b); wherein the at least one second open sipe 33 appears wavelike as seen in plan view and has two ends that respectively open into the at least one second pair of major grooves 30 at at least one central location in the tire circumferential direction CD of the at least one second block land (32, 32b); and wherein amplitude Wo of the at least one second open sipe 34 is greater than amplitude We of the at least one second closed sipe 33; and wherein wavelength Lo of the at least one second open sipe 34 is less than wavelength Lc of the at least one second closed sipe 33; wherein the first block column G1 passes through a tire equator, and the second block column G2 is adjacent to the first block column G1; wherein the at least one first open sipe 34 and the at least one first closed sipe 33 are inclined in mutually similar fashion with respect to the tire width direction WD; wherein the at least one second open sipe 34 and the at least one second closed sipe 33 are inclined in mutually similar fashion with respect to the tire width direction WD; and wherein the first sipes (33, 34) and the second sipes (33, 34) are inclined in mutually opposite fashion with respect to the tire width direction WD.

As a result of adoption of this constitution, it will be possible to prevent the traction produced by sipes 33, 34 from causing drift toward one side in the tire width direction WD.

As is the case in the present embodiment, it is preferred that the tire has at least third block land (32, 32c) that is partitioned by at least one third pair of lateral grooves 31 and at least one third major groove 30a arranged in outwardmost fashion in the tire width direction WD, the at least one third block land (32, 32c) making up at least one third block column G3 arranged along the tire circumferential direction CD; wherein the at least one third block land (32, 32c) has at least one third open sipe 35 that appears wavelike as seen in plan view, has two ends that respectively open into the at least one pair of lateral grooves 31, and partitions the at least one third block land (32, 32c) into at least one outer portion 32d and at least one inner portion 32e in the tire width direction WD.

During turns, a lateral force may act on shoulder block land 32c, causing occurrence of a type of motion in which outer land 32d of shoulder block land 32c is made to slide in the tire circumferential direction CD relative to inner land 32e. However, because longitudinal open sipes 35 are sipes that appear wavelike as seen in plan view, it is possible to reduce excessive movement of outer land 32d at shoulder block land 32c relative to inner land 32e, and it is possible to suppress uneven wear.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
at least one first block land that is partitioned by at least one first pair of major grooves and at least one first pair of lateral grooves, the at least one first block land making up at least one first block column arranged along a tire circumferential direction;
wherein the at least one first block land has at least one first closed sipe and at least one first open sipe;
wherein the at least one first closed sipe appears wavelike as seen in plan view, extends in a tire width direction, and has two ends that respectively terminate within the at least one first block land;
wherein the at least one first open sipe appears wavelike as seen in plan view and has two ends that respectively open into the at least one first pair of major grooves at at least one central location in the tire circumferential direction of the at least one first block land; and
wherein amplitude of the at least one first open sipe is greater than amplitude of the at least one first closed sipe; and
wherein wavelength of the at least one first open sipe is less than wavelength of the at least one first closed sipe.

2. The pneumatic tire according to claim 1 wherein the amplitude of the at least one first open sipe is not less than 1.2 times but not greater than 3.0 times the amplitude of the at least one first closed sipe.

3. The pneumatic tire according to claim 1 wherein the wavelength of the at least one first open sipe is not less than 0.5 times but not greater than 0.9 times the wavelength of the at least one first closed sipe.

4. The pneumatic tire according to claim 1 wherein
the amplitude of the at least one first open sipe is not less than 1.0 mm but not greater than 5.0 mm; and
the wavelength of the at least one first open sipe is not less than 3.0 mm but not greater than 7.0 mm.

5. The pneumatic tire according to claim 1 further comprising
at least one second block land that is partitioned by at least one second pair of major grooves and at least one second pair of lateral grooves, the at least one second block land making up at least one second block column arranged along the tire circumferential direction;
wherein the at least one second block land has at least one second closed sipe and at least one second open sipe;
wherein the at least one second closed sipe appears wavelike as seen in plan view, extends in the tire width direction, and has two ends that respectively terminate within the at least one second block land;
wherein the at least one second open sipe appears wavelike as seen in plan view and has two ends that respectively open into the at least one second pair of major grooves at at least one central location in the tire circumferential direction of the at least one second block land; and
wherein amplitude of the at least one second open sipe is greater than amplitude of the at least one second closed sipe; and
wherein wavelength of the at least one second open sipe is less than wavelength of the at least one second closed sipe;
wherein the first block column passes through a tire equator, and the second block column is adjacent to the first block column;
wherein the at least one first open sipe and the at least one first closed sipe are inclined in mutually similar fashion with respect to the tire width direction;
wherein the at least one second open sipe and the at least one second closed sipe are inclined in mutually similar fashion with respect to the tire width direction; and
wherein the first sipes and the second sipes are inclined in mutually opposite fashion with respect to the tire width direction.

6. The pneumatic tire according to claim 1 further comprising
at least third block land that is partitioned by at least one third pair of lateral grooves and at least one third major groove arranged in outwardmost fashion in the tire width direction, the at least one third block land making up at least one third block column arranged along the tire circumferential direction;
wherein the at least one third block land has at least one third open sipe that appears wavelike as seen in plan view, has two ends that respectively open into the at least one pair of lateral grooves, and partitions the at least one third block land into at least one outer portion and at least one inner portion in the tire width direction.
